(19) United States
(12) Patent Application Publication
(10) Pub. No.: US 2011/0149341 A1
(43) Pub. Date: Jun. 23, 2011

(54) IMAGE FORMING APPARATUS, HOST APPARATUS, AND METHOD OF CONTROLLING THE SAME

(75) Inventor: Chang-gun KO, Suwon-si (KR)

(73) Assignee: Samsung Electronics Co., Ltd., Suwon-si (KR)

(21) Appl. No.: 12/913,952

(22) Filed: Oct. 28, 2010

(30) Foreign Application Priority Data
Dec. 23, 2009 (KR) 10-2009-129981

(51) Int. Cl. G06F 3/12

(52) U.S. Cl. 358/1.15

(57) ABSTRACT

A method of controlling a host apparatus which is connectable with at least one image forming apparatus via a universal serial bus (USB) includes connecting the image forming apparatus having a storage unit in which at least one application program is stored with the host apparatus. The host apparatus recognizes the image forming apparatus as a disk drive corresponding to a mass storage class and displays the mass storage disk drive on a display of the host apparatus. A user of the host apparatus may use an explorer program to select an application stored in the mass storage disk drive. Accordingly, an application program that provides a UI stored in the image forming apparatus is loaded and executed in the host apparatus to enable convenient control and status identification of the image forming apparatus using the displayed UI without an additional installation process.

### CROSS-REFERENCE TO RELATED APPLICATIONS

This application claims the benefit of priority under 35 U.S.C. §119 from Korean Patent Application No. 10-2009-0129981, filed on Dec. 23, 2009 in the Korean Intellectual Property Office, the disclosure of which is incorporated herein by reference in its entirety.

### BACKGROUND

1. Field of the Invention

Apparatuses and methods consistent with exemplary embodiments relate to an image forming apparatus, a host apparatus, and a method of controlling the same, and more particularly, to an image forming apparatus, a host apparatus, and a method of controlling the same in which a host apparatus recognizes an image forming apparatus in which an application program is stored as a disk drive, and the application program in the image forming apparatus is loaded and executed in the host apparatus.

2. Description of the Related Art

An image forming apparatus forms an image printed on paper. The image forming apparatus may be a printer, a copy machine, a fax, a multifunctional device having two or more functions, etc.

The image forming apparatus may include an input button to input commands from a user through, or a light emitting diode (LED) or a liquid crystal display (LCD) panel to display an operation state.

However, an image forming apparatus displaying an operation state with an LED only represents the apparatus in error or normal mode using colors of the LED. In the case of an image forming apparatus employing an LCD panel, the LCD panel is limited in size, e.g., to a two-line LCD panel, due to hardware constraints. Therefore, there are limitations in properly delivering status information to a user.

In addition, the number and type of the input buttons on the image forming apparatus may be limited due to hardware constraints. Thus, if a user wants to input various settings including numbers such as an IP address, he/she may need to manipulate direction keys in different directions several times, which may be inconvenient.

An application program to control the image forming apparatus may be installed in a host apparatus connected via a network to conveniently control the image forming apparatus, but this requires an additional installation process with an installation CD which may be inconvenient, and if the installation CD is lost, it may be difficult to install the application program in a host device.

### SUMMARY

Accordingly, one or more exemplary embodiments of the present general inventive concept provide an image forming apparatus, a host apparatus, and a method of controlling the same in which the host apparatus recognizes the image forming apparatus connected via a USB or other data port as a disk drive, and an application program stored in the image forming apparatus is loaded and executed by the host apparatus to provide a UI on the host apparatus, to thereby provide convenient control and status identification of the image forming apparatus using the displayed UI without an additional installation process.

Another exemplary embodiment provides an image forming apparatus, a host apparatus, and a method of controlling the same which is capable of establishing a user-oriented control environment through setting up keyboard shortcuts of a virtual UI program or adding/deleting/changing individual widget programs as an application program.

Additional aspects and utilities of the present general inventive concept will be set forth in part in the description which follows and, in part, will be obvious from the description, or may be learned by practice of the present general inventive concept.

The foregoing and/or other features or utilities of the present general inventive concept may be achieved by a method of controlling a host apparatus which is connectable with at least one image forming apparatus via a universal serial bus (USB), the method including: connecting an image forming apparatus having a storage unit in which at least one application program is stored with the host apparatus, recognizing the image forming apparatus as a disk drive corresponding to a mass storage class to be displayed in the host apparatus and exploring at least one application program in the displayed disk drive, performing the explored application program, and displaying the application program controlling the image forming apparatus in the host apparatus.

The method may further include driving the image forming apparatus corresponding to input by a user when the input by the user is made to the displayed application program.

The driving the image forming apparatus may include changing a pre-input setting value of the image forming apparatus or displaying or executing a function supported by the image forming apparatus, and the function may include at least one of printing, copying, scanning, faxing, file transmission, and direct printing.

The performing may include performing the explored application program by in response to a selection from an input device or automatically performing the application program.

The application program may include at least one of a virtual user interface (UI) program corresponding to an operation panel of the image forming apparatus which enables a user to input and at least one widget displaying information of the image forming apparatus.

The virtual UI program may display a display area showing a current status of the image forming apparatus or a function of the image forming apparatus and at least one user input button.

The method may further include selecting an input button displayed by execution of the virtual UI program and controlling the image forming apparatus to correspond to the selected input button.

The widget may include at least one of a plurality of programs to load and display status information, toner information, a scanner status, a fax status, and process information from the image forming apparatus and a widget manager to control the plurality of programs.

The widget may added, deleted, or changed.

The displaying in the host apparatus may include displaying a list of at least one program, and the method may further include selecting one program from the list and displaying information of the image forming apparatus corresponding to the selected program.

The displaying in the host apparatus may include displaying an icon corresponding to the application program on a system tray on a wallpaper of the host apparatus.

Features and/or utilities of the present general inventive concept may also be realized by a host apparatus which is connectable with at least one image forming apparatus via a universal serial bus (USB), the host apparatus including a communication unit including a USB interface connected to an image forming apparatus having a storage unit in which at least one application program is stored, a display displaying a user interface (UI) of the application program, a memory loading the application program, and a controller to recognize the image forming apparatus as a disk drive corresponding to a mass storage class to be displayed on the display when connecting with the image forming apparatus via the USB interface, to explore and execute the application program in the displayed disk drive to be loaded to the memory, and to control the display to display the UI of the loaded application program.

The host apparatus may further include a user input unit including the displayed UI and may receive input by a user, wherein the controller may control the communication unit to transmit a command of driving the image forming apparatus corresponding to input by a user when inputting the input by the user to the displayed UI.

The driving the image forming apparatus may include changing a pre-input setting value of the image forming apparatus or displaying or executing a function supported by the image forming apparatus, and the function may include at least one of printing, copying, scanning, faxing, file transmission, and direct printing.

The host apparatus may further include a user input unit to receive input by a user, and the controller may perform the explored application program by click on the user input unit or allows the application program to be performed automatically.

The application program may include at least one of a virtual user interface (UI) program corresponding to an operation panel of the image forming apparatus which enables a user to input and at least one widget displaying information of the image forming apparatus.

The virtual UI program may display a display area showing a current status of the image forming apparatus or a function of the image forming apparatus and at least one user input button.

The widget may include at least one of a plurality of programs to load and display status information, toner information, a scanner status, a fax status, and process information from the image forming apparatus and a widget manager controlling the plurality of programs.

The display may display an icon corresponding to the application program on a system tray on a wall paper of the host apparatus.

Features and/or utilities of the present general inventive concept may also be achieved by providing an image forming apparatus which is connectable with at least one host apparatus via a universal serial bus (USB), the image forming apparatus including a communication unit including a USB interface to support a printer class and a mass storage class, a storage unit in which a file allocation table (FAT) and at least one application program are stored, and a controller to inform the host apparatus that the USB interface supports the printer class and the mass storage class when connecting to the host apparatus via the USB interface and controlling the communication unit to load the application program to the host apparatus.

Features and/or utilities of the present general inventive concept may also be achieved by a method of controlling an image forming apparatus including recognizing with a host apparatus that an image forming apparatus connected to the host apparatus includes a data storage drive accessible by a user of the host apparatus, and displaying the data storage drive on a display of the host apparatus that includes each data storage drive accessible by the host apparatus.

The method may include connecting an image forming apparatus to a host apparatus and downloading from the image forming apparatus an application to display a user interface corresponding to functions of the image forming apparatus on a display of the host apparatus, and the application is saved and executed from a RAM device of the host apparatus.

The application may be a virtual UI depicting a control panel having buttons corresponding to one or more functions of the image forming apparatus, and the buttons may be selectable by a user of the host apparatus to execute the corresponding one or more functions of the image forming apparatus.

The application may be a widget application to display at least one icon corresponding to a function of the image forming apparatus, and when a user selects the icon, data corresponding to the function of the image forming apparatus is displayed on the host apparatus.

Features and/or utilities of the present general inventive concept may also be realized by a non-transitory computer-readable medium having stored thereon code execute a method in a host apparatus and an image forming apparatus connected to the host apparatus, the method including recognizing with the host apparatus that the image forming apparatus connected to the host apparatus includes a data storage drive accessible by a user of the host apparatus and displaying the data storage drive on a display of the host apparatus that includes each data storage drive accessible by the host apparatus.

Features and/or utilities of the present general inventive concept may also be realized by a non-transitory computer-readable medium having stored thereon code execute a method in a host apparatus and an image forming apparatus connected to the host apparatus, the method including connecting an image forming apparatus to a host apparatus and downloading from the image forming apparatus an application to display a user interface corresponding to functions of the image forming apparatus on a display of the host apparatus, and the application may be saved and executed from a RAM device of the host apparatus.

Features and/or utilities of the present general inventive concept may also be realized by a host apparatus to control an image-forming apparatus, the host apparatus including a display to display data, RAM to temporarily store data, a data interface to transmit and receive data from an image forming apparatus external to the host apparatus, and a controller to receive an application from the image forming apparatus to display data corresponding to the image forming apparatus on the display, to temporarily store the application in RAM, and to control the display to display the application.

The data interface may be a USB interface.

The controller may receive the application from a data storage drive of the image forming apparatus, and the host apparatus may recognize the data storage drive as a mass storage device accessible by a user of the host apparatus.

The controller may control the display to display a virtual operation panel of the image forming apparatus including at least one function of the image forming apparatus.

The virtual operation panel may include at least one imaging function button, a menu button, and a keypad.

The controller may control the display to display at least one widget corresponding to functions of the image forming apparatus.

Features and/or utilities of the present general inventive concept may also be realized by an image forming apparatus including an imaging unit to perform an imaging function of a document, a data storage device to store at least one application to control operation of the image forming apparatus, a data communication unit to connect to a host device to receive imaging commands from the host device, and a controller to control transmission of data between the data storage device and the host device via the data communication unit, and to control the imaging unit.

The data storage device may include a file allocation table to transmit to the host device, such that at least a portion of the data storage device is controllable by a user of the host device as a mass data storage device.

The data communication unit may transmit to the host device an application stored in the data storage device to display on a display of the host device data corresponding to functions of the image forming apparatus.

The application may include a virtual control panel to control operations of the imaging unit of the image forming apparatus.

The application may include at least one widget to display data corresponding to a status of a function of the image forming apparatus.

### BRIEF DESCRIPTION OF THE DRAWINGS

The above and/or other aspects of the present general inventive concept will become apparent and more readily appreciated from the following description of the exemplary embodiments, taken in conjunction with the accompanying drawings, in which:

FIG. 1 is a block diagram illustrating a configuration of an image forming apparatus and a host apparatus according to an exemplary embodiment of the present general inventive concept.

FIG. 2 illustrates a virtual UI panel displayed on a second display according to an embodiment of the present general inventive concept.

FIGS. 3 to 8 illustrate a data file stored in an application program storage block according to an exemplary embodiment of the present general inventive concept.

FIGS. 9, 12, and 14 illustrate a widget program stored in an application program storage block according to another exemplary embodiment of the present general inventive concept.

FIGS. 10, 11, and 13 illustrate an execution screen of the widget program displayed on a second display according to an exemplary embodiment of the present general inventive concept.

FIG. 15 is a flow chart illustrating a method of executing an application program according to an exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

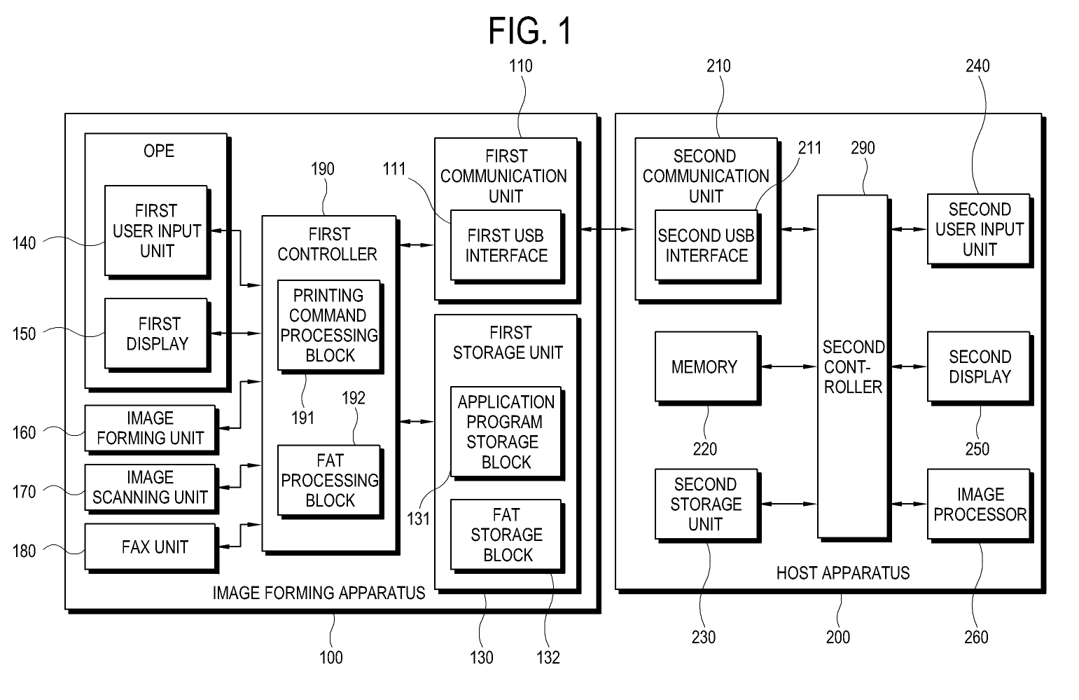

FIG. 1 is a block diagram illustrating a configuration of an image forming apparatus 100 and a host apparatus 200 according to one exemplary embodiment of the present general inventive concept.

An image forming apparatus 100 of the present general inventive concept may be a multifunctional device having two or more functions among printing, copying, scanning, and faxing, a printer, or the like.

As shown in FIG. 1, the image forming apparatus 100 according to an exemplary embodiment of the present general inventive concept includes a first communication unit 110, a first storage unit 130, a first user input unit 140, a first display 150, an image forming unit 160, an image scanning unit 170, a fax unit 180, and a controller 190. The image forming apparatus may receive a recording medium, such as paper to scan with the scanning unit 170 and to print via the image forming unit 160. The image forming apparatus 100 may also receive a document electronically, such as via the fax unit 180 or the first communication unit 110 and print or fax the received document via the image forming unit 160 and the fax unit 180, respectively.

The first communication unit 110 communicates with external devices including the host apparatus 200 and a server, and receives print data made up of one or more print languages from devices external to the image forming apparatus 100.

As shown in FIG. 1, the first communication unit 110 may include a first Universal Serial Bus (USB) interface 111 (e.g., a USB port) which is connected to the host apparatus 200 via a USB cable to interface for reception and transmission of data. Here, the first USB interface 111 can interface with a portable storage medium such as a USB memory. Although the present embodiment includes a USB interface 111, and other data interface may be used.

The first USB interface 111 of the image forming apparatus 100 may support a printer class and a mass storage class (MSC). In other words, connecting the image forming apparatus 100 to an external device via the first USB interface 111 may allow the image forming device 100 to communicate with the external device as a printer or as a data storage device.

Since the mass storage class supports a device driver of a corresponding class in an operating system (OS) level, the image forming apparatus 100 connected to the host apparatus 200 is set up to be identified as a disk drive (e.g., a portable disk (H:)) in an explorer (e.g., Window Explorer) or other program to identify programs, files, and hardware. Accordingly, the host apparatus 200 recognizes the image forming apparatus 100 connected via the first USB interface 111 as a printing device and disk drive (e.g., a mass storage unit), which means that the image forming apparatus 100 has both a printing function and a disc function of storing a file such as a USB memory.

Meanwhile, if the image forming apparatus 100 is a multifunctional device, the first USB interface 111 may further support a vendor specific class.

The first communication unit 110 further includes a cable or wireless communication module connected locally or via a network according to a protocol to an external device such as the host apparatus 200. The first communication unit 110 may transmit a scan data to an external device such as the host apparatus 200 or a server according to a protocol by Scan to Host and Scan to Server settings, to another external device via a Scan to Email setting, or to a USB memory connected via a Scan to USB setting.

The first storage unit 130 stores various print data for printing, a fax data for faxing, an image data scanned by the image scanning unit 170, a data received from an external device including the host apparatus 200, a PC, a server, etc. which are connected via the first communication unit 110, a variety of settings of the image forming apparatus 100 through the first user input unit 140, information for user confirmation by user accounts, information about right of use, etc. The first storage unit 130 may further store a fax data received through a fax unit 180 from an outside fax machine.

The first storage unit 130 includes an internal storage medium such as a hard disk drive (HDD) or external or portable storage module devices such as a USB memory, a memory card (memory sticks, Compact Flash (CF) cards, and MultiMediaCard (MMC)), a memory card slot, etc.

The first storage unit 130 of the image forming apparatus 100 of the present inventive concept includes an application program storage block 131 and a file allocation table (FAT) storage block 132, as shown in FIG. 1.

The application program storage block 131 stores an application program providing a user interface (UI) (e.g., Virtual_UI.exe or WidgetManager.exe). The application program may include at least one of a virtual UI program to display a UI panel including at least one menu key for user's selection and at least one widget program to display information about the image forming apparatus 100 by displaying status icons, for example.

The application program storage block 131 may include an autorun file to execute an application program automatically, e.g., an autorun.inf file. The autorun.inf file is set up to perform an application program, e.g., [autorun] open=Virtual_UI.exe or [autorun] open=WidgetManager.exe.

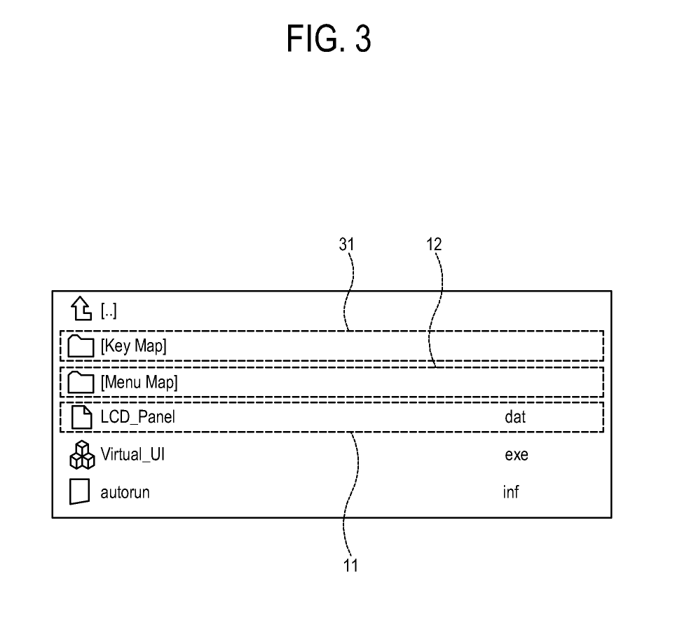

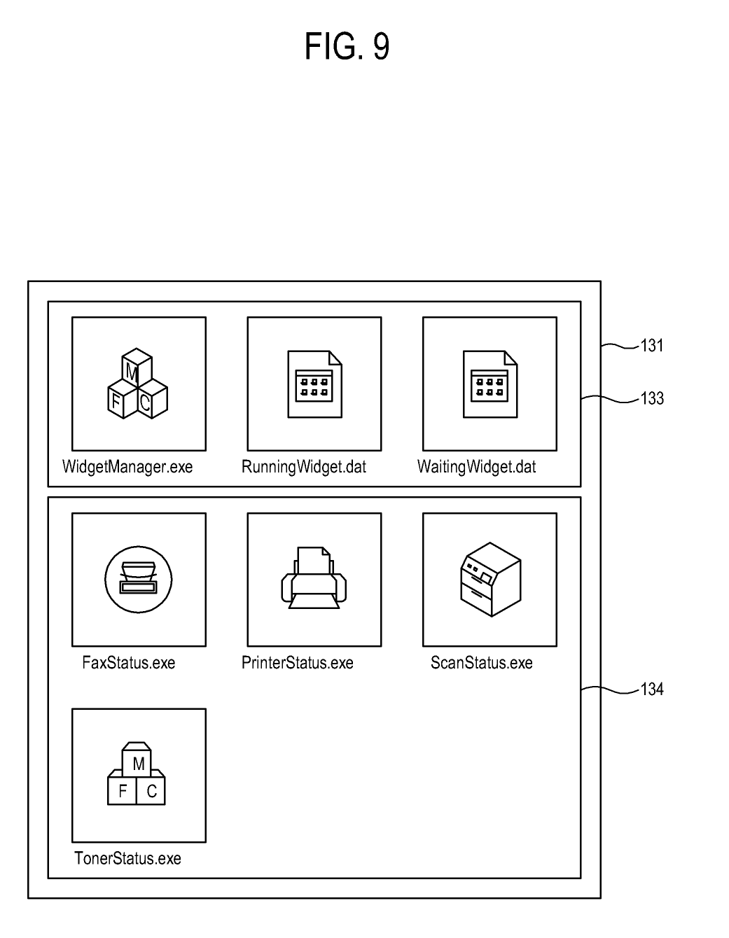

Further, the application program storage block 131 may further store folders and data files to form a menu tree having information corresponding to a virtual UI program shown in FIGS. 3 to 8, described below, or a widget program file shown in FIGS. 9 to 14.

The FAT storage block 132 stores file allocation tables to set up the image forming apparatus 100 as a disk drive. When the image forming apparatus turns on, the file allocation table is executed and sets up the first storage unit 130 of the image forming apparatus to be recognized as a disk drive. The file allocation table may enable a portion of the first storage unit 130, e.g., the application program storage block 131, to be recognized as a disk drive.

Further, if the first storage unit 130 is a portable storage medium, the first storage unit 130 may further include a memory card block (not shown) and a terminal to connect to an interface of the image forming apparatus 100. For example, the first communication unit 110 may include multiple data ports such as USB ports, and the first storage unit 130 may connect to the image forming apparatus 100 via one of the USB ports. In such a case, the first storage unit 130 may also be disconnected from the data port.

The first user input unit 140 receives a data or a command from a user. The first user input unit 140 may include an input button (hereinafter, also referred to as a hard key or key pad) provided in the image forming apparatus 100 and a graphic user interface (GUI, also referred to as a user interface (UI)) generated by execution of an application and displayed on the first display 150 for a user to input by touching.

A user may perform a login process of inputting an ID allocated to each user account and a password through the first user input unit 140. A login may include login in an administrator mode which allows a user to setup and change all configuration of the image forming apparatus 100 without any limitation on access.

When a user's login or login in the administrator mode is carried out, the image forming apparatus 100 performs identification and permission. In the present inventive concept, a user may login as an administrator.

The first display 150 displays a UI screen to show setup and operation states to a user and to input various commands through from the user. The first display 150 may include a liquid crystal display (LCD) and a driver (not shown) to drive the LCD.

Meanwhile, in the image forming apparatus 100 of the present general inventive concept, the first user input unit 140 may be realized as a GUI using a touch screen on the first display 150 to allow user's selection, which means the first user input unit 140 and the first display 150 are not provided separately but formed in a single unit.

A configuration including the first user input unit 140 and the first display 150 in image forming apparatus 100 is referred to as an operation panel (OPE).

The image forming unit 160 forms an image printed on at least one recording medium such as paper on the basis of a print data under a printing instruction. The printing operation may include printing a received fax data, printing a scanned document for copy, and printing a data received from the outside via the host apparatus 200 including a server or stored in the first storage unit 130 in an HDD of the image forming apparatus 100 or in an external memory (USB memory).

The image scanning unit 170 scans a document (a paper) to be scanned to generate a scan data. The document to be scanned may include a document, a photo, a film, etc. The image scanning unit 170 may include an optical converter including a charge-coupled device (CCD), contact image sensor (CIS)), etc. and an image processor to process a document into an image data using a signal output from the optical converter. Further, the image scanning unit 170 may further include a scan motor which drives the optical converter and the image processor, and a guide.

Meanwhile, a scan data scanned by the image scanning unit 170 may be converted into a fax signal to be transmitted by the fax unit 180 to an external fax machine.

The fax unit 180 may include a fax communication module (e.g., a modem) which changes an image data generated by the image scanning unit 170 into a fax signal and transmits it to an external fax machine (including a multifunctional device with a faxing function) via the public switched telephone network (PSTN), or receives a fax signal from an external fax machine.

The first controller 190 controls the various functional units of the image forming apparatus 100. The first controller 190 may include a printing command processing block 191 and an FAT processing block 192, as shown in FIG. 1.

The printing command processing block 191 controls operations of the image forming apparatus 100 as a printing device, related to printing, scanning, faxing, etc. For example, the printing command processing block 191 may control one of the image forming unit 160, the image scanning unit 170, and the faxing unit 180 to perform a process corresponding to user's command received from the host apparatus 200 through the first user input unit 140 or the first USB interface 111 of the first communication 110.

The FAT processing block 192 executes a file allocation table stored in the first storage unit 130 and sets up the first storage unit 130 of the image forming apparatus 100 to be recognized as a disk drive when the image forming apparatus 100 turns on.

Specifically, when the image forming apparatus 100 turns on and USB enumeration is performed in the host apparatus 200 connected to the image forming apparatus 100 via a USB cable, the FAT processing block 192 controls the first USB interface 111 to inform the host apparatus 200 that the first USB interface 111 of the image forming apparatus supports a printer class and a mass storage class, or a printing device and a mass storage device.

Accordingly, the host apparatus 200 may recognize a portion of the first storage unit 130, e.g., the application program storage block 131, as a disk drive (e.g., a portable disk (H:)).

The printing command processing block 191 controls the image forming apparatus 100 to receive user's command using a UI of an application program from the host apparatus 200 to amend a data file (e.g., Command.dat) in the application program storage block 131 and to perform a corresponding operation.

Further, the printing command processing block 191 amends a data file (e.g., LCD_Panel.dat) in the application program storage block 131 when the image forming apparatus 100 changes in state.

The host apparatus 200 reflects a data file amended as above to renew a UI of an application program.

The host apparatus 200 may be a Personal Computer (PC) and may include a server controlling at least image forming apparatus 100.

As shown in FIG. 1, the host apparatus 200 includes a second communication unit 210, a memory 220, a second storage unit 230, a second user input unit 240, a second display 250, an image processor 260, and a second controller 290.

The second communication unit 210 carries out data communication with an external device including the image forming apparatus 100, and receives a print data formed of printing languages from outside the host apparatus 200.

As shown in FIG. 1, the second communication unit 210 may include a second USB interface 211 (e.g., a USB port) connected to the host apparatus 200 via a USB cable to interface for reception and transmission of data. Here, the second USB interface 211 can interface with a portable storage medium such as a USB memory.

When the image forming apparatus 100 turns on and the host apparatus 200 is detected being connected to the image forming apparatus 100 via a USB cable, the second USB interface 211 performs USB setup. That is, the second USB interface 211 executes USB enumeration and recognizes that the first USB interface 111 supports a printer class and a mass storage class according to information received from the image forming apparatus 100. When the image forming apparatus 100 is a multifunctional device, the second USB interface 211 may further recognize the first USB interface 111 further supports a vendor specific class.

The second controller 290 of the host apparatus 200 may load and install a device driver corresponding to a class that the first USB interface 111 of the image forming apparatus 100 supports. The loaded device driver is supported in an OS level and may be stored in advance in the second storage unit 230. The first storage unit 130 may store a plurality of device drivers corresponding to a plurality of different operating systems, and the second controller 290 may select an appropriate device driver from the stored device drivers according to the operating system of the host apparatus 200.

When completing the installation of the loaded device, the host apparatus 200 sets up the image forming apparatus 100 connected via USB in the form of a disk drive and displays it on the second display 250, and a user executes an explorer or file, program, and device organization and display program (e.g., Window Explorer) and identifies it as a disk drive (e.g., a portable disk (H:)) in the visual display of the explorer. For example, a user may open an explorer program, locate an icon representing the portable disk H:, and click on the icon with a mouse, touch screen, or other selection device to access the contents of the first storage unit 130.

The second communication unit 210 further includes a cable or wireless communication module connected locally or via a network according to a protocol to an external device such as the image forming apparatus 100.

The memory 220 loads a program executed in the host apparatus 200 temporarily and is realized as RAM. The memory 220 of the host apparatus 200 loads an application program (e.g., a virtual UI program or widget program) stored in the application program storage block 131 of the first storage unit 130 of the image forming apparatus 100 when the application program is executed.

The second storage unit 230 includes an internal storage medium such as an HDD or external and/or portable storage module devices such as a USB memory, a memory card (memory sticks, CF cards, and MMC), a memory card slot, etc., and stores OS for operation of the host apparatus 200, a device driver to identify a device connected to the host apparatus 200 via USB, etc.

The second user input unit 240 receives a data or a command from a user. The second user input unit 240 includes a keyboard, a mouse, etc. provided as an input device of the host apparatus 200 and may include a graphic user interface (GUI, also referred to as a UI) generated by execution of a driver or an application and displayed on the second display 250 for a user to input.

The second user input unit 240 of the host apparatus 200 includes a UI (e.g., a virtual UI panel, a widget program icon, a widget program execution window, etc.) generated by execution of an application program loaded from the image forming apparatus 100.

A user carries out a login process of inputting an ID allocated to each user account and a password through the second user input unit 240. Here, login includes login in an administrator mode which allows a user to setup and change all configuration of the image forming apparatus 100 without any limitation on access.

When user's login or login in the administrator mode is carried out, the image forming apparatus 100 performs identification and permission.

The second display 250 displays a UI showing setup and operation states of the image forming apparatus 100 to a user and generated by execution of an application program loaded from the image forming apparatus 100. The second display 250 may include an LCD and a driver (not shown) to drive the LCD. The host apparatus 200 may include a second display 250 that is integral with the host apparatus body, such as a laptop computer, or the display 250 may be connected to the second controller 290 via a cable, cord, wire or other data connection. In such a case, the second controller 290 and the image processor 260 may generate signals to a data port and the second display 250 may be detachable connected to the data port.

The image processor 260 generates a print data formed of printing languages according to a printing command through the second user input unit 240. The print data generated is transmitted to the image forming apparatus 100 through the second USB interface 211. The image processor 260 may include a printer driver.

The second controller 290 controls the various functional units of the host apparatus 200. Specifically, when the second USB interface 211 detects connection of the host apparatus 200 and the image forming apparatus 100 via a USB cable and executes USB enumeration to recognize that the first USB interface 111 of the image forming apparatus supports a printer class and a mass storage class, the second controller 290 loads and installs a device driver corresponding to a class supported by the first USB interface 111 from the second storage unit 230.

Accordingly, the second controller 290 displays the image forming apparatus 100 via setting up as a disk drive, and a user executes an explorer (e.g., Window Explorer) to identify the disk drive (e.g., a portable disk (H:)).

When completely setting up the image forming apparatus 100 as a disk drive in the host apparatus 200, the second controller 290 explores and performs an application program file stored in the application program storage block 131 of the image forming apparatus 100. The application program provides a user UI displayed on the second display 250, and the image forming apparatus 100 may be controlled through the displayed user UI.

The host apparatus 200 loads and performs an application program from the image forming apparatus 100 recognized as a disk drive to the memory 220 without passing through a separate process of installing or storing the application program in the host apparatus 200. That is, any information is not added to a registry of the host apparatus 200.

Accordingly, without any installation process of a program in the host apparatus 200, the application program can be executed and the image forming apparatus 100 can be controlled. The second controller 290 may access application data directly from the first storage unit 130 of the image forming apparatus 100 via the first communication unit 110. The second controller 290 may temporarily store files and data corresponding to the executed application in memory 220, which may be short-term, or RAM, memory without permanently installing the application from the image forming apparatus 100.

The second controller 290 may download and install a driver to control operation of the image forming apparatus 100 from the first storage unit 130 without installing UI applications such as a virtual user interface application to display a virtual user interface on the second display 250 of the host apparatus 200, or a widget application to display one or more icons, such as status icons to indicate a status of the image forming apparatus 100, on the second display 250. In other words, a driver to control the image forming apparatus 100 may be stored in the second storage unit 230, which may be a long-term memory unit, such as a hard disk, and the applications such as a virtual UI application and a widget application may be stored only in the RAM 220 as they are executed by the second controller 290.

Alternatively, the second controller 290 may temporarily download and store both the driver to control the image forming apparatus 100 and one or more applications such as the virtual user interface application or widget application from the first storage unit 130. The second controller 290 may store the driver and applications in the second storage unit 230 and erase the stored applications from the memory 220 or second storage unit 230 when it detects that the image forming apparatus 100 has been disconnected from the host apparatus 200.

Whether the driver and applications are stored in the memory 220 or second storage unit 230 of the host apparatus 200 may be determined by manufacturer or vendor settings, or may be determined by user settings.

That is, the image forming apparatus 100 is driven in accordance with user's input through UI of the displayed application program. Here, driving the image forming apparatus includes changing preset settings of the image forming apparatus 100, or displaying or executing a function supported by the image forming apparatus 100, wherein the function includes at least one of printing, copying, scanning, faxing, file transmission, and direct printing (i.e., USB printing). The file transmission includes at least one of emailing a data scanned by the image scanning unit 170 or a data pre-stored in the storage unit 130 of the image forming apparatus and transmittable to the outside and sending them to an external device such as an FTP, a server, etc.

An exemplary embodiment of the present general inventive concept includes an application program stored in the application program storage block 131 of the image forming apparatus 100, wherein a virtual UI program is loaded to the memory 220 of the host apparatus 200 and executed.

If the application program storage block 131 includes an autorun file, i.e., autorun.inf, the second controller 290 performs an execution file of the virtual UI program, Virtual_UI.exe, via plug and play (PnP). Here, the autorun file is set up in advance to execute a virtual UI panel application program as [autorun] open=Virtual_UI.exe.

Meanwhile, a user may perform or execute the virtual UI program by selecting an icon of the virtual UI program using an explorer. For example, the user may move a cursor on the second display 250 over an icon or text representing the virtual UI program in an explorer program, and may select the program by clicking, double-clicking, or any other manner of selection. In addition, the user may enter a name and address of the program into a command line to execute the program.

When the virtual UI program stored in the image forming apparatus 100 is loaded to the memory 220 and performed, the second controller 290 controls the second display 250 to display a virtual UI panel. The second controller 290 may control the second display 250 by transmitting a signal, or causing the image processor 260 to generate a signal, to a data port connected to the second display 250, for example.

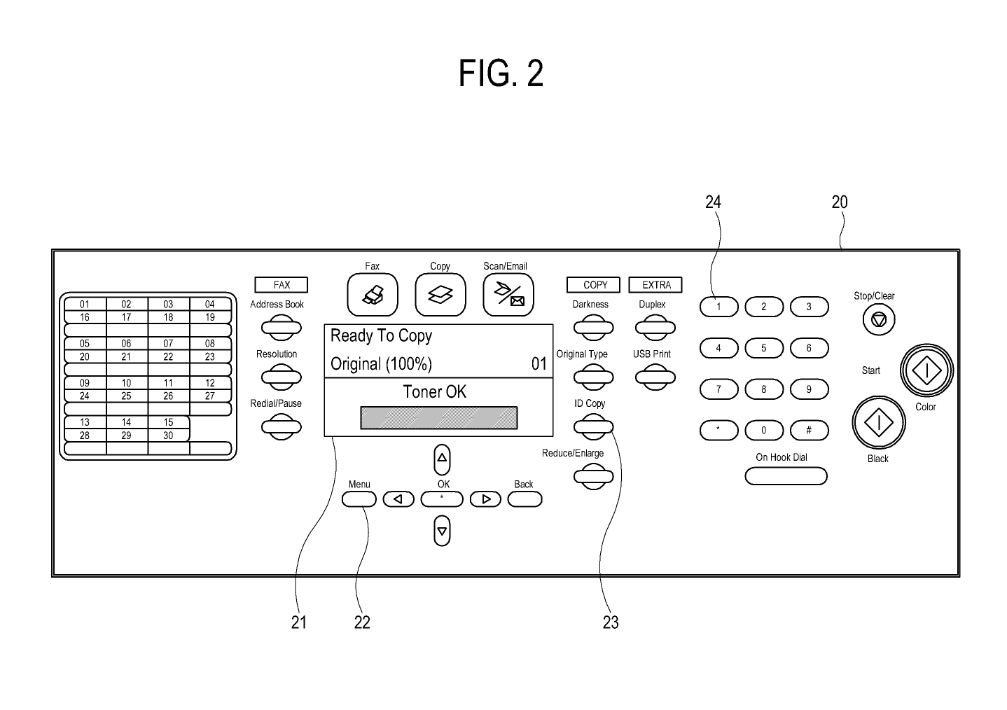

FIG. 2 illustrates a virtual UI panel 20 displayed on the second display 250 according to an exemplary embodiment of the present inventive concept, and FIGS. 3 to 8 illustrate a data file stored in the application program storage block 131 according to this exemplary embodiment.

As shown in FIG. 2, the virtual UI panel 20 may correspond to an operation panel (OPE) of the image forming apparatus 100 and may include a display area including a virtual LCD panel 21 displaying information about a current status of the image forming apparatus 100 or the like and a menu key 22, a function key 23, and number keys 24 which may be selected or manipulated by a user.

The virtual LCD panel 21 may be displayed as not only a four-line LCD panel, shown in FIG. 2, but various forms of panels having various configurations and representations of different functional keys.

The application program storage block 131 stores a data file corresponding to the virtual LCD panel 21, LCD_Panel.dat 11, shown in FIG. 3.

LCD_Panel.dat is a data file 11 including information displayed on the virtual LCD panel 21 in FIG. 2 and may be formed of binary data files expressing the LCD panel in pixels or ASCII data files having only character information. The application program storage block 131 also stores the data maps including the structure of files and programs that correspond to the keys 31 and menus 12 of the virtual UI application.

When user's manipulation through the first user input unit 140 of the image forming apparatus 100 or changes in the stated of the image forming apparatus 100 (e.g., a lack of a toner, a printing error, etc.) occur, the first controller 190 of the image forming apparatus 100 amends LCD_Panel.dat.

When LCD_Panel.dat is amended, the virtual UI program loads the amended LCD_Panel.dat file, and the second controller 290 controls the second display 250 to renew or refresh the virtual LCD panel 21 to display the changed data of the amended LCD_Panel.dat file 11.

The menu key 22 of the virtual UI panel 20 receives user's selection of a menu.

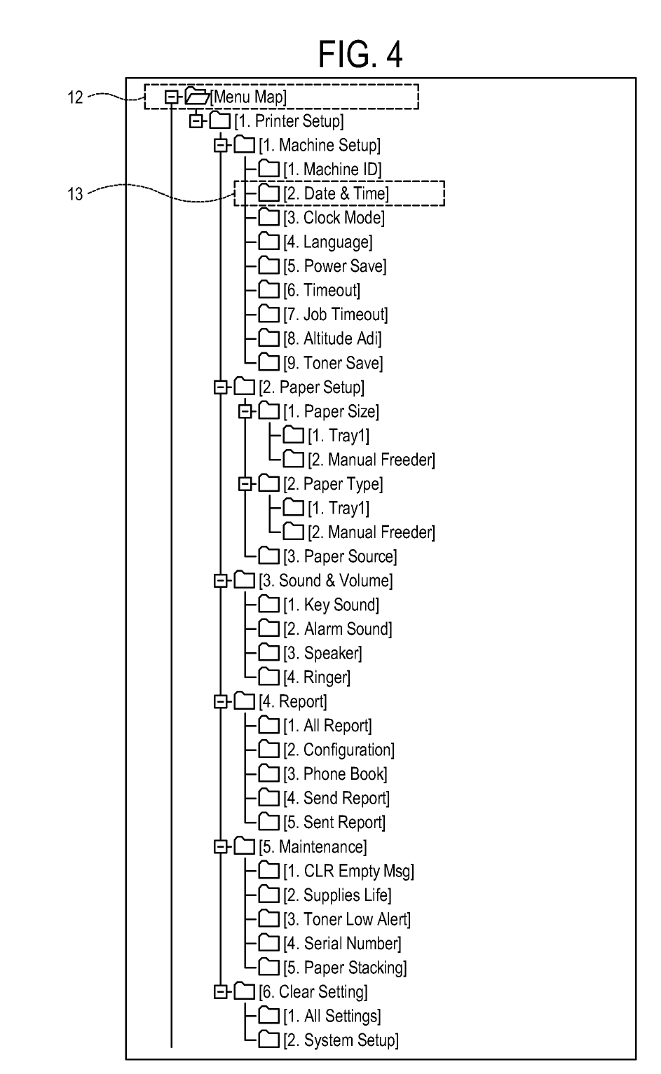

When receiving a user's selection through the menu key 22, the second controller 290 loads a folder name corresponding to a selected menu key 22 of the virtual LCD panel from the application program storage block 131 to form a menu tree, shown in FIG. 4.

A folder name is designated by adding a preset prefix (e.g., 1., 2., 3. or a., b., c., etc.) in front of each folder name forming the menu tree. The second controller 290 identifies a folder name in a subfolder using the prefixes.

A user may amend a folder name in consideration of a designated prefix and store a Command.dat file in a subfolder in the lowest level to change the menu tree stored in the application program storage block 131 or to add a new menu.

When a menu map folder 12 is set up in a disk drive, i.e., a portable disk H: \, shown in FIG. 4, and when a user clicks the menu key 22, the second controller 290 loads a corresponding file path from the application program storage block 131 and displays a folder in the highest level, e.g., Printer setup, on the second display 240.

When a user manipulates the menu key 222 in the order of Printer Setup, Machine Setup, and Data & Time, the second controller 290 enters Command.dat in the Data & Time folder 13 of the lowest menu.

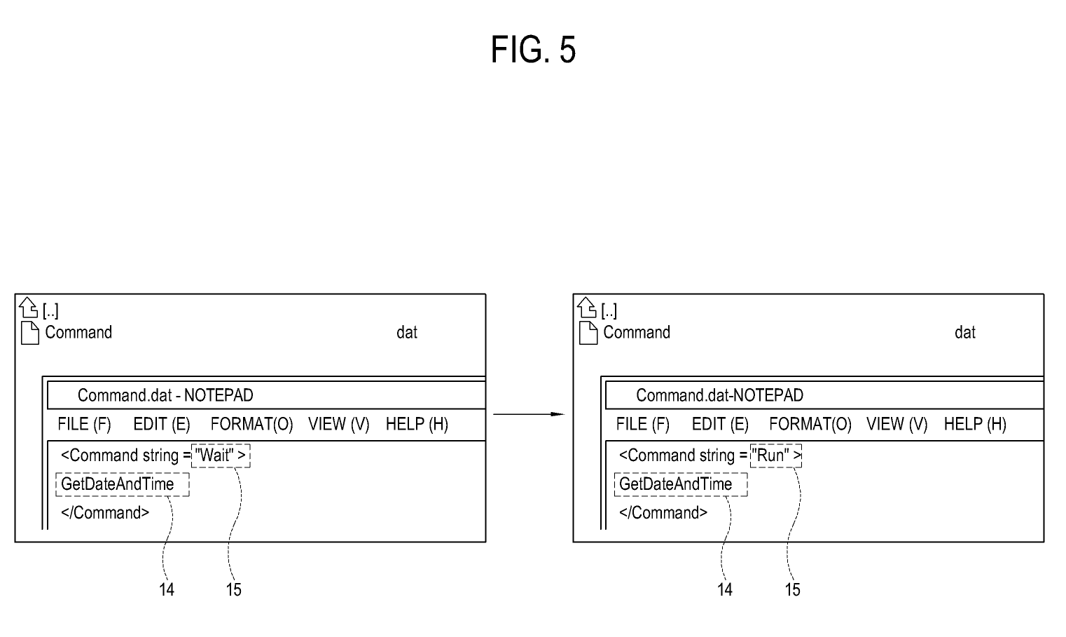

As shown in FIG. 5, the Command.dat file includes a letter row (GetDateAndTime) 14 indicating a currently executed command and a letter row (string=“Wait”) 15 indicating a current status.

When a user selects a menu key corresponding to Data & Time, the second controller 290 changes the letter row 15 indicating a current status of the Command.dat file from string=“Wait” to string=“Run” as shown in FIG. 5.

The first controller 190 of the image forming apparatus 100 detects a change of the Command.dat file of Data & Time loaded to the host apparatus 200 and reads out a corresponding letter row string=“Run” to perform a corresponding command, i.e., GetDateAndTime. Then, the first controller 190 amends LCD_Panel.dat which is a file having information displayed on the virtual LCD panel 21 according to a performance result of the GetDateAndTime command, and the second controller 290 loads the amended LCD_Panel.dat file and controls the second display 250 to display a changed virtual LCD panel 21.

The function key 23 receives user's selection corresponding to a function supported by the image forming apparatus 100.

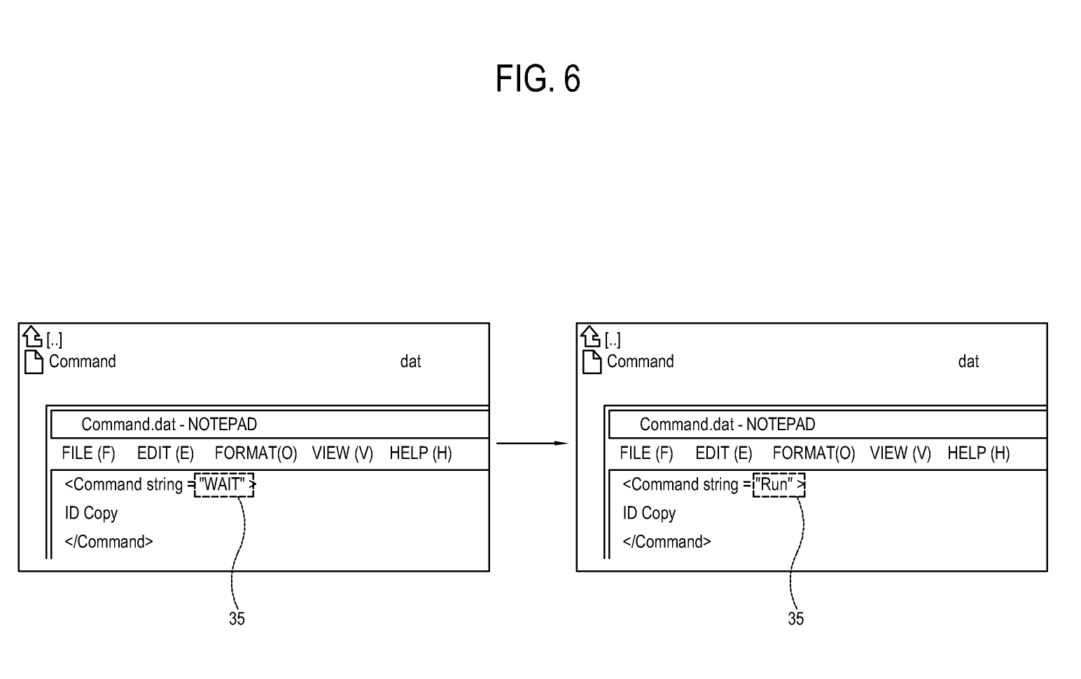

For example, if a user selects a function key 23 corresponding to ID copy, the second controller 290 loads a preset path, e.g., a folder name of \\KeyMap\ID_Copy, corresponding to the selected function key 23 of the virtual UI panel 20 to set up a menu tree and enters the Command.dat file of ID Copy to change the letter row 35 indicating a current status from string=“Wait” to string=“Run” as shown in FIG. 6.

The first controller 190 of the image forming apparatus detects a change of the Command.dat file of ID Copy loaded to the host apparatus 200, and the printing command processing block 171 controls the image scanning unit 170 and the image forming unit 160 to read out a corresponding letter row string=“Run” and to perform a corresponding ID Copy function.

The first controller 190 amends LCD_Panel.dat having information displayed on the virtual LCD panel 21 according to a performance result of the ID Copy function, and the second controller 290 loads the amended LCD_Panel.dat file and controls the second display 250 to display an ID Copy performance result on the virtual LCD panel 21.

Meanwhile, a button of the virtual UI panel 20 may be set up as a keyboard shortcut of a function supported by the image forming apparatus 100.

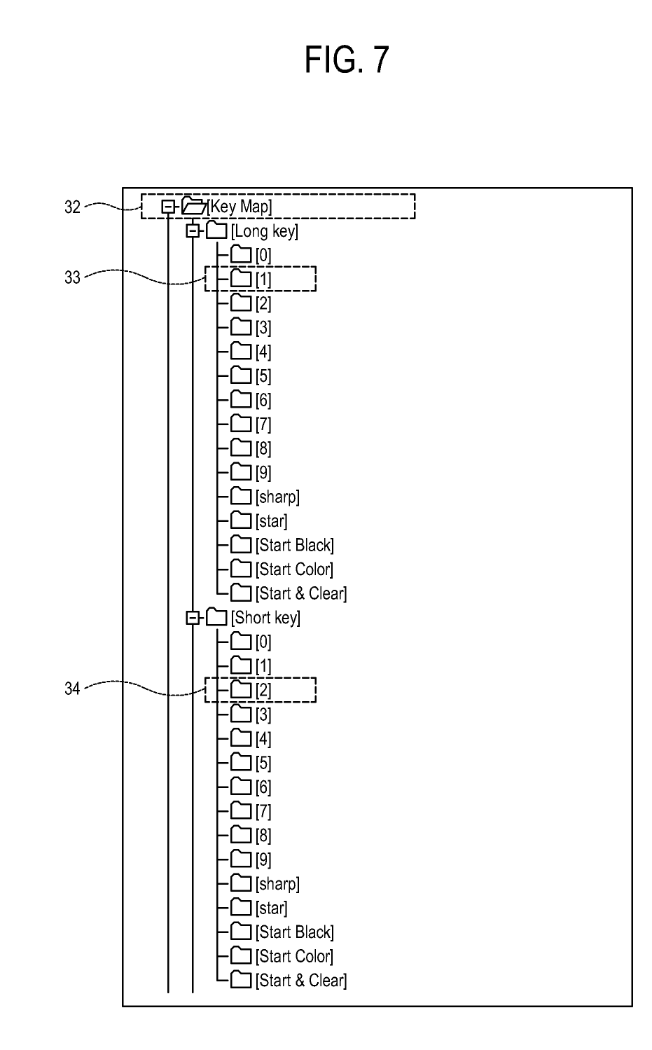

As shown in FIG. 7, the application program storage block 131 stores a folder set up in the same configuration as the buttons displayed on the virtual UI panel 20.

A user may amend a Command.dat file in each folder of the folder configuration in FIG. 7 to set up a keyboard shortcut.

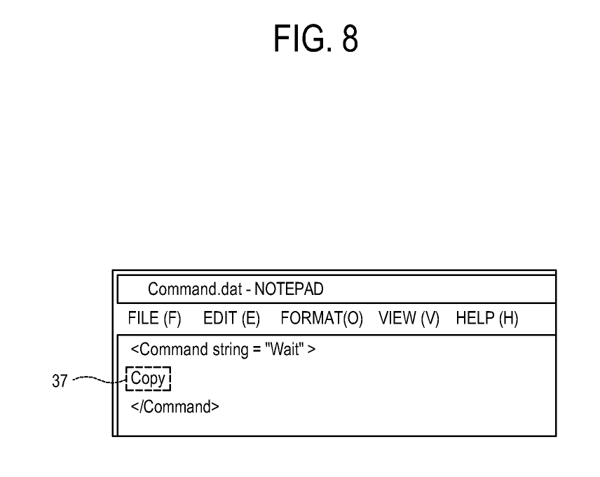

For example, to set up a keyboard shortcut of performing a copy function when the number “1” of the number keys 24 is clicked for a long interval (33), a user inputs a letter row 37 in a file of \\KeyMap\LongKey\1\Command.dat as shown in FIG. 8 and stores it in the application program storage block 131.

Then, if the user presses the number “1” of the number keys 24 on the virtual UI panel 20 for a preset period time, e.g., 3 seconds or more, the second controller 290 changes string=“Wait” in the file of \\KeyMap\LongKey\1\Command.dat to string=“Run”, and the printing command processing block 191 of the image forming apparatus 100 reads a data of the changed \\KeyMap\LongKey\1\Command.dat file from the application program storage block 131 and controls the image scanning unit 170 and the image forming unit 160 to carry out a copy command corresponding to the letter row 35 (Copy) indicating the command.

In the same manner, a user may set up a keyboard shortcut of performing a copy function when the number “2” of the number keys 24 is clicked for a short duration of time (34) by inputting a letter row in a file of \\KeyMap\ShortKey\2\Command.dat as shown in FIG. 8 and storing it in the application program storage block 131.

Thus, even if a user terminates execution of the virtual UI panel 20, the virtual UI program may remain as a system tray icon on the display 250 of the host apparatus 200 so that the user can use the virtual UI panel 20 by clicking the tray icon if needed.

Meanwhile, the virtual UI program may be stored in a memory card block (not shown) if the first storage unit 130 is a portable storage medium.

Specifically, the memory card block stores the virtual UI program of Virtual_UI.exe, an autorun program set up to execute the virtual UI program automatically that is autorun.inf, etc., and the second controller 290 loads the virtual UI program stored in the memory card block to the memory 220 of the host apparatus 200 and executes it.

A type of a memory card supporting the memory card block includes an SD card, an MMC card, a Smart Media card, an xD card, a Compact Flash card I/II, an MS/MS Pro card, and all mini types thereof.

This embodiment of the present general inventive concept may be realized by the process of amending the status of the command.dat file from string=“Wait” to string=“Run” as explained with reference to FIGS. 3 to 8, but the present general inventive concept may also be achieved by executing a virtual UI application program using a device driver of a printer class supported by the first USB interface 111.

Specifically, if a user clicks specific buttons on the virtual UI panel 20, the second controller 290 transmits a corresponding Command.dat file to the image forming apparatus 100 by a bulk out through the device driver of the printer class.

Command.dat defines a data representing a specific command (e.g., copy) in advance (e.g., 1B F3 38 00) and stores it in the file to be sent to the image forming apparatus 100. The image forming apparatus 100 analyzes the data received to a bulk channel of the printer class and performs a corresponding operation, i.e., copying.

The first embodiment of the present inventive concept conveniently controls driving the image forming apparatus 100 using a UI of an application program, i.e., a virtual UI, without installing an additional program or storing a data in the host apparatus 200 and enables control of the image forming apparatus under the same condition all the time regardless of a change in the host apparatus 200 connected to the image forming apparatus via a USB port.

Further, a user may perform at least one of changing, adding, and deleting a file stored in a folder of a menu tree and a folder of a specific button to build a user-oriented virtual UI panel 20, which is optimized for a user.

Another exemplary embodiment of the present general inventive concept is an application program stored in the application program storage block 131 of the image forming apparatus 100, wherein at least one widget program is loaded to the memory 220 of the host apparatus 200 and executed.

The widget program is an execution program and includes a widget manager controlling an individual widget and at least one individual widget as a program displaying a status of each function of the image forming apparatus 100. In other words, a widget is a display or icon representing data regarding a status of functions of the image forming apparatus 100. The widget may be displayed on the second display 250 of the host apparatus 200 and selected by a user to edit or receive additional information regarding the selected function of the image forming apparatus 100.

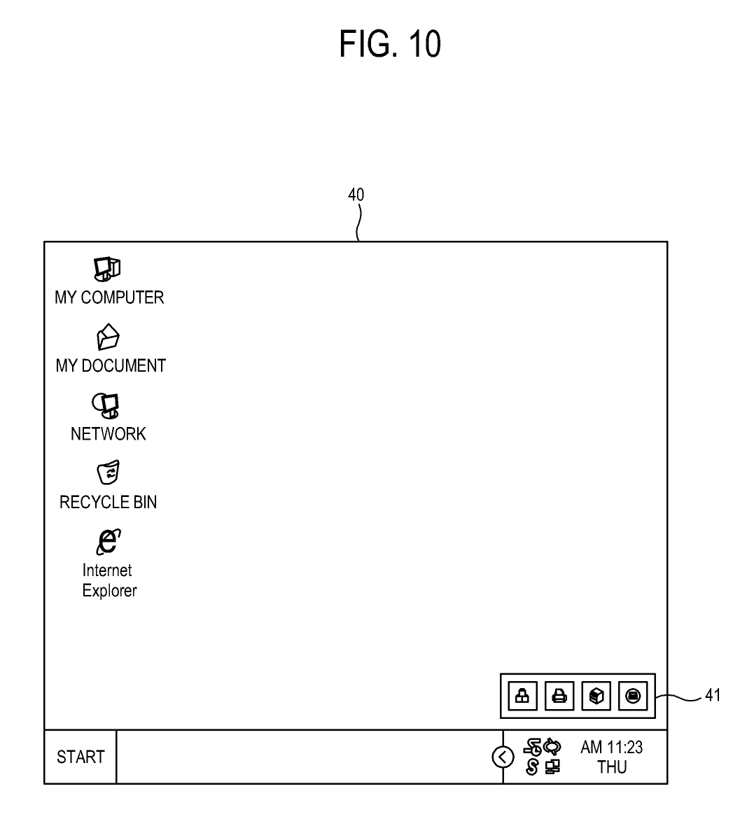

FIGS. 9, 12, and 14 illustrate a widget program stored in an application program storage block 131 according to this exemplary embodiment of the present general inventive concept, and FIGS. 10, 11, and 13 illustrate an execution screen of the widget program displayed on the second display 250 of the host apparatus 200.

As shown in FIG. 9, the application program storage block 131 may include a manager area 133 in which a widget manager is stored and a program area 134 in which an individual widget controlled by the widget manager is stored. The manager area 133 and the program area 134 may be stored either in separate portions of the first storage unit, in different storage units or memory devices, or stored together within the application program storage block 131.

The manager area 133 stores an execution file of the widget manager, WidgetManager.exe, and a data file indicating an execution status of the individual widget, RunningWidget.dat and WaitingWidget.dat.

RunningWidget.dat and WaitingWidget.dat store a currently performing widget and a currently not performing widget, i.e., a widget in a standby mode, among individual widgets stored in the program area 134, respectively.

The program area 134 stores an execution of an individual widget displaying a status of each function supported by the image forming apparatus 100.

Referring to FIG. 9, for example, an individual widget may include a program to display an amount of a toner which is TonerStatus.exe, a program to display a current status of the image forming apparatus 100 which is PrinterStatus.exe, a program to display a current status of a scanner which is ScanStatus.exe, and a program to display a current status of a fax which is FaxStatus.exe. A user may optionally add a widget to the program area 134 based on different functions of the image forming apparatus 100. Additionally, the user may receive a widget from a device external to the host apparatus 200 and image forming apparatus 100, such as via a network, to store in the application program storage block 131 and to display on the second display 250.

The application program storage block 131 may further include an autorun file, i.e., autorun.inf. If including an autorun file, the second controller 290 performs the execution file of the widget manager, WidgetManager.exe., by the PnP operation in a setup process. Here, the autorun file is set up in advance as [autorun] open=WidgetManager.exe in order to perform the widget manager.

Meanwhile, the user may perform the widget manager by selecting an icon of the widget manager through an explorer.

When the widget manager stored in the image forming apparatus 100 is loaded to the memory 220 and performed, the second controller 290 controls the second display 250 to display an execution screen of a widget program, shown in FIG. 10.

As shown in FIG. 10, the second controller 290 controls the second display 250 to display an icon list 41 of individual widgets stored in the program area 134 in a portion of a PC wallpaper 40 according to execution of the widget manager.

The user selects an icon from the icon list 41 displayed in FIG. 10 and executes a function corresponding to an individual widget.

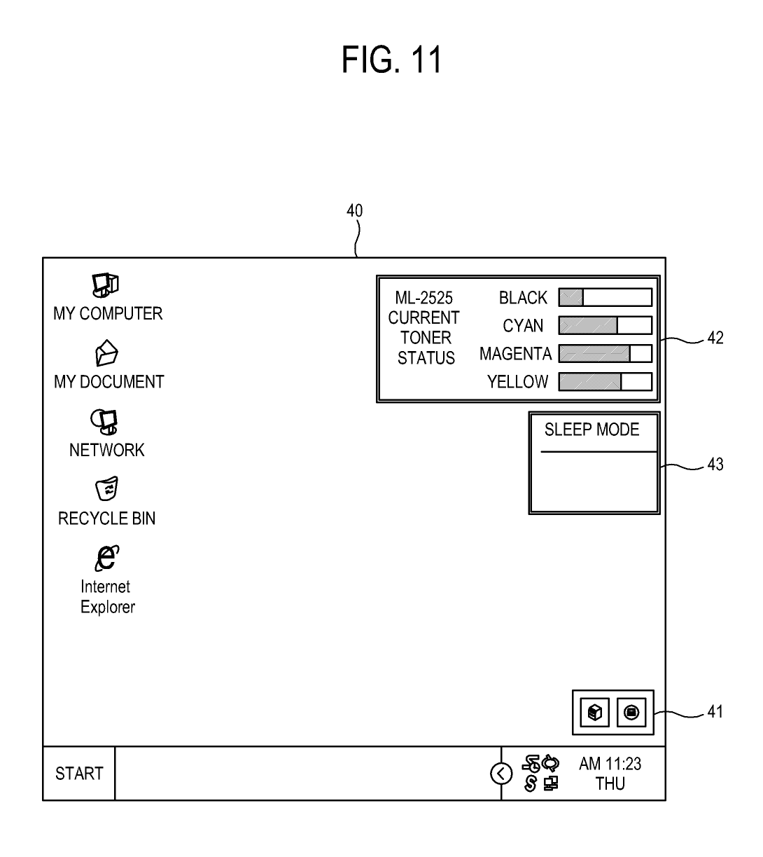

For example, if the user selects the program displaying an amount of a toner and the program displaying a current status of the image forming apparatus 100, the second controller 290 loads an execution file of corresponding individual widgets to the memory 220 and controls the second display 250 to display status windows 42 and 43 corresponding to the selected individual widgets, shown in FIG. 11. The second controller 290 may control the second display 250 to display to delete an icon of an executed individual widget from the icon list 41.

The second controller 290 reflects an execution result of an individual widget on RunningWidget.dat and WaitingWidget.dat in the manager area 133.

In particular, when the program displaying an amount of a toner and the program displaying a current status of the image forming apparatus 100 are performed as shown in FIG. 11, the second controller 290 adds TonerStatus.exe and PrinterStatus.exe in RunningWidget.dat and deletes them from WaitingWidget.dat.

When the user finishes a performed program displaying an amount of a toner, an icon of a toner status is added to the icon list 41, and TonerStatus.exe is deleted from RunningWidget.dat and may be added to WaitingWidget.dat again.

Meanwhile, RunningWidget.dat may be set up in advance to include an execution file of predetermined individual widget.

For example, when RunningWidget.dat is set up in advance to include PrinterStatus.exe, which displays a status of the image forming apparatus 100, and when the widget manager is executed by USB connection of the image forming apparatus 100 and the host apparatus 200, the second controller 290 explores a list of individual widgets stored in RunningWidget.dat and automatically performs PrinterStatus.exe, which displays a status of the image forming apparatus 100 to display the icon list 41 and the status window 43 on the second display 250.

An individual widget thus automatically executed may be set up and stored in the manager area 133 when manufacturing the image forming apparatus 100 or may be set up by a user directly amending RunningWidget.dat.

Meanwhile, individual widgets stored in the program area 134 may be added, deleted, or edited according to a user's selection.

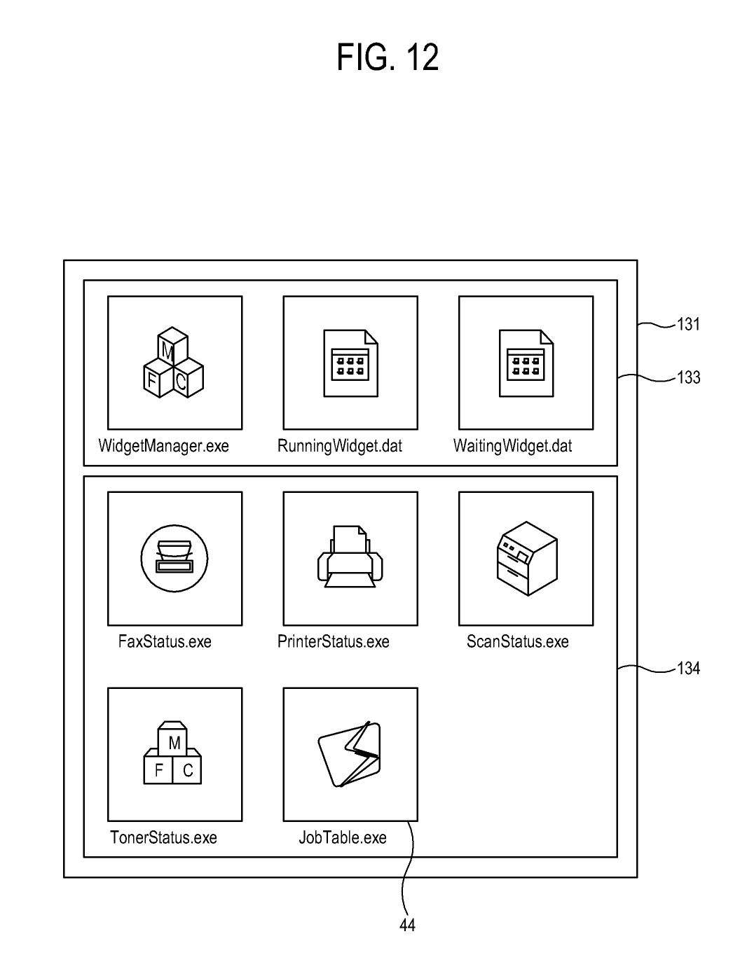

Specifically, a user may add a widget having a function, e.g., JobTable.exe 44, to the application program storage block 131 recognized as a disk drive, e.g., a portable disk (H:), using an explorer (e.g., Window Explorer), shown in FIG. 12.

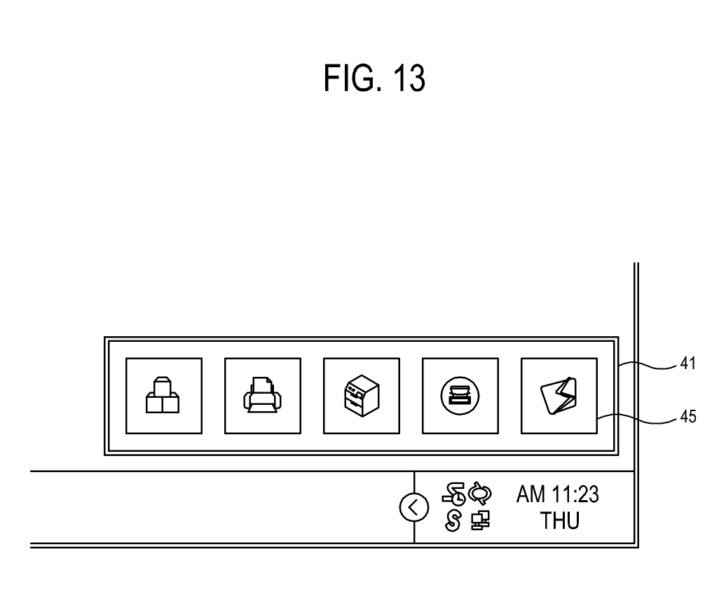

When adding a widget using an import function of the widget manager or detecting addition of an individual widget using an automatic recognition function, the second controller 290 controls the second display 250 to display an icon 45 corresponding to the added widget in the icon list 41, shown in FIG. 13.

The widget thus added may be provided by a manufacturer via a network, email, etc. Furthermore, a user may ask a manufacturer to add an individual widget in a Voice of Customer (VOC) form, and an added individual widget includes not only programs controlling the image forming apparatus 100 but various programs for user's convenience.

In addition, the user may delete an unnecessary widget from the application program storage block 131. When a specific individual widget is deleted using an explorer, an icon corresponding to the deleted widget is deleted from the icon list 41.

When executing the widget manager, the second controller 290 regularly examines input/output of a list of individual widgets stored in the image forming apparatus 100 and renews WaitingWidget.dat to reflect addition or deletion of an individual widget according to user's selection on the second display 250.

Accordingly, the user may be provided with various needed widgets and delete unnecessary widgets, to thereby establish a user-oriented environment.

According to an embodiment of the present inventive concept, an inactive area set up in the program area 134 may be used to change a save position of an individual widget, so that the individual widget is deleted from the icon list 41 without deleting it.

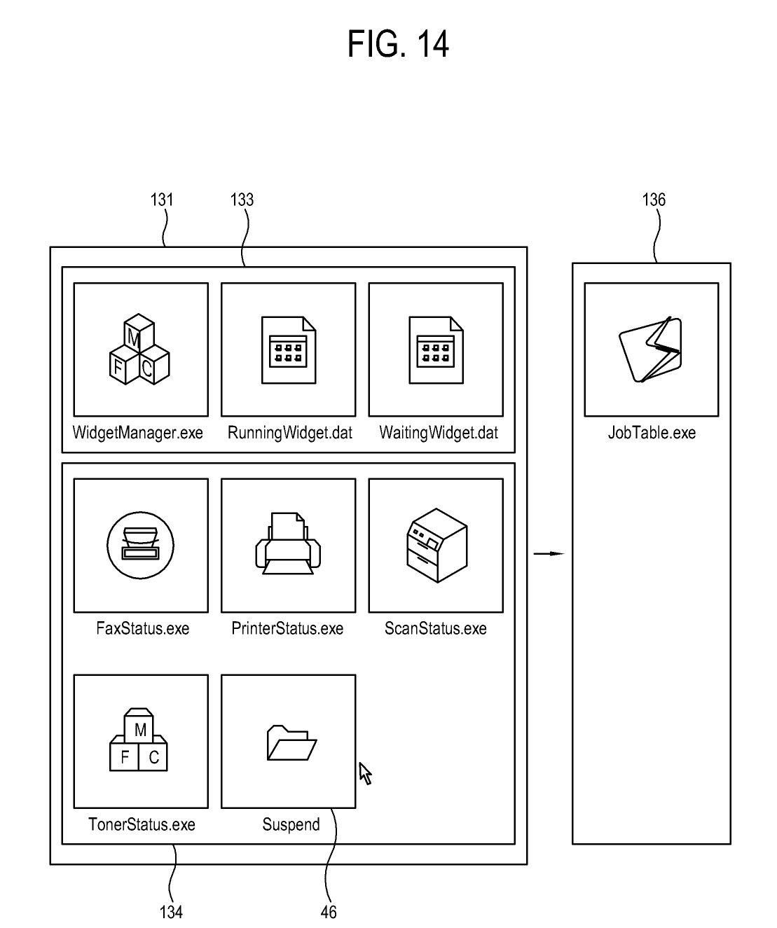

As shown in FIG. 14, the user may create a folder 46 (Suspend) corresponding to the inactive area of the program area 134 and store a widget which is not frequently used, e.g., JobTable.exe, in the inactive folder 46.

The second controller 290 excludes a program in the inactive folder 46 from input/output examination of a list of individual widgets.

The user may move a program in the inactive folder 46 to the program area 134 to display it in the icon list 41.

According to the present embodiment, even if a user terminates execution of the icon list 41, the widget manager may not be finished but may remain as a system tray icon on the wallpaper of a PC so that the user can use the icon list 41 by clicking the tray icon if needed.

The widget program may be stored in a memory card block (not shown) if the first storage unit 130 is a portable storage medium.

Specifically, the memory card block stores the widget manager of WidgetManager.exe, individual widgets of TonerStatus.exe, PrinterStatus.exe, ScanStatus.exe, FaxStatus.exe, etc., an autorun program set up to execute the widget manager automatically that is autorun.inf, etc., and the second controller 290 loads the widget manager and a selected individual widget program stored in the memory card block to the memory 220 of the host apparatus 200 and executes it.

A type of a memory card supporting the memory card block includes an SD card, an MMC card, a Smart Media card, an xD card, a Compact Flash card I/II, an MS/MS Pro card, and all mini types thereof.

The widget application conveniently controls the image forming apparatus 100 using a UI of an application program without installing an additional program or storing a data in the host apparatus 200 and enables control of the image forming apparatus 100 under the same condition all the time regardless of a change in the host apparatus 200 connected to the image forming apparatus via a USB port.

Further, a user may add, delete, and change an individual widget program to build a user-oriented widget program environment, which is optimized for a user.

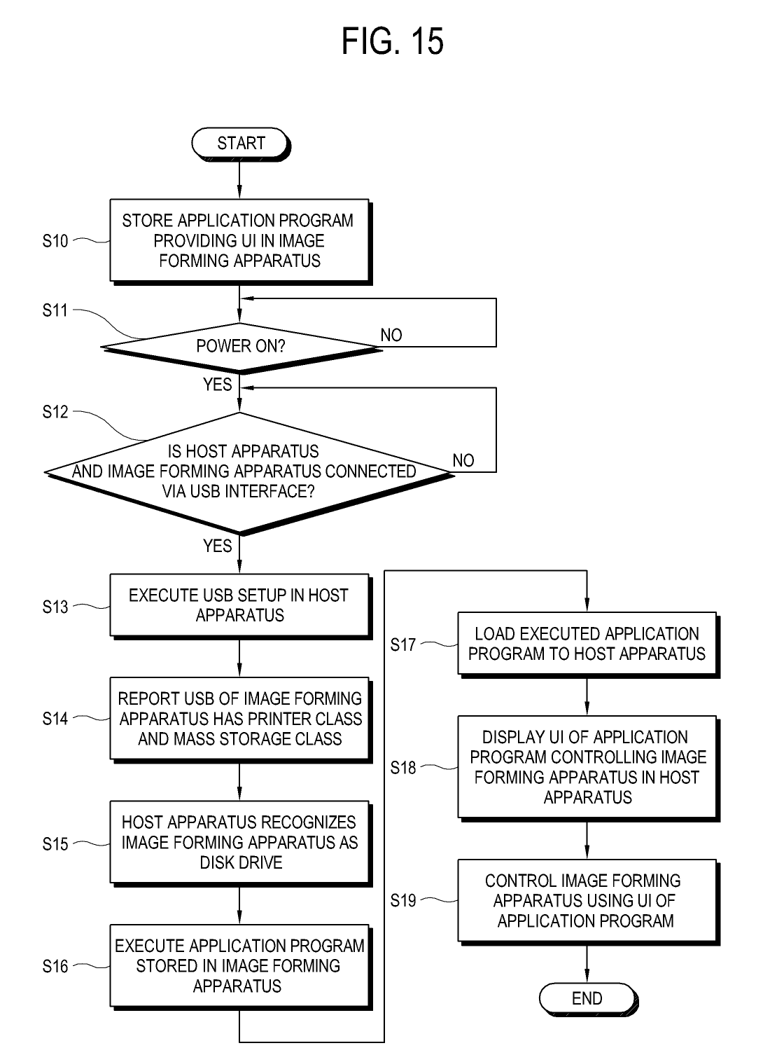

Hereinafter, a process of the host apparatus 200 performing an application program will be explained with reference to FIG. 15 in regard to the image forming apparatus 100 and the host apparatus 200 described above.

In FIG. 15, the image forming apparatus 100 and the host apparatus 200 are connected via a USB interface, and a USB interface of the image forming apparatus 100 may support a printer class and a mass storage class.

As shown in FIG. 15, in operation S10, an application program providing a UI may be stored in advance in the application program storage block 131 of the image forming apparatus 100. The application program may include at least one of a virtual UI program displaying a UI panel including at least one button to allow user's selection and at least one widget displaying information about a function supported by the image forming apparatus 100.

In operation S11, power may be supplied to the image forming apparatus 100. For example, the image forming apparatus 100 may be turned on, may exit a low-power mode, or may be plugged in.

When the image forming apparatus 100 is turned on at S11, the host apparatus 200 detects in operation S12 that the host apparatus 200 is connected to the image forming apparatus 100 via a USB interface.

In operation S13, the host apparatus 200 performs USB setup. The second USB interface 211 of the host apparatus 200 may carry out USB enumeration.

At operation S14, the image forming apparatus 100 informs the host apparatus 200 that the first USB interface 111 of the image forming apparatus 100 corresponds to each of a printer class and a mass storage class. Here, in the case the image forming apparatus is realized as a multifunctional device, the host apparatus 200 may be informed the first USB interface 111 may further include a vendor specific class.

In operation S15, host apparatus 200 recognizes the image forming apparatus 100 as a disk drive (e.g., a portable disk (H:)) through S13 and S14. The host apparatus 200 loads and installs a device driver corresponding to a class supported by the first USB interface 111 of the image forming apparatus 100. The loaded device driver is supported in an OS level and may be stored in advance in the host apparatus 200.

At operation S16, the host apparatus 200 executes the application program stored in the image forming apparatus 100 at S10. The application program is automatically performed or executed by user's selection (double click on an execution file) using an explorer.

In operation S17, the application program performed at S16 is loaded to the memory 220 of the host apparatus 200 from the image forming apparatus 100.

According to loading at S17, a UI of the application program controlling the image forming apparatus 100 is displayed in the host apparatus 200 in operation S18.

In operation S19, a user may control the image forming apparatus 100 using the UI of the application program displayed on the second display 250 according the execution at S16. The second display 250 displays an icon corresponding to the application program on a system tray on a wallpaper of the host apparatus 200, and the second controller 290 does not completely shut down the application program but enables execution of the application program by using the icon on the system tray even if the user closes the displayed UI.

At operation S19, the user controls the image forming apparatus 100 using the virtual UI panel 20 shown in FIG. 2, or identifies and controls an operation state of each function supported by the image forming apparatus 100 by selecting the widget program icon list 41 shown in FIG. 10.

As described above, according to the image forming apparatus, the host apparatus, and the method of controlling the same according to the present general inventive concept, the host apparatus recognizes the image forming apparatus connected via a USB port as a disk drive, and an application program providing a UI stored in the image forming apparatus is loaded and executed in the host apparatus, to thereby enable convenient control and status identification of the image forming apparatus using the displayed UI without an additional installation process.

Further, a user-oriented control environment may be established through setting up keyboard shortcuts of a virtual UI program or adding/deleting/changing individual widget programs as an application program.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, DVDs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. A method of controlling a host apparatus which is connectable with at least one image forming apparatus via a universal serial bus (USB), the method comprising:
connecting an image forming apparatus having a storage unit in which at least one application program is stored with the host apparatus;
recognizing the image forming apparatus as a disk drive corresponding to a mass storage class to be displayed in the host apparatus and exploring at least one application program in the displayed disk drive;
performing the explored application program; and
displaying the application program controlling the image forming apparatus in the host apparatus.

2. The method according to claim 1, further comprising driving the image forming apparatus corresponding to input by a user, when the input by the user is made to the displayed application program.

3. The method according to claim 2, wherein the driving the image forming apparatus comprises changing a pre-input setting value of the image forming apparatus, or displaying or executing a function supported by the image forming apparatus, and the function comprises at least one of printing, copying, scanning, faxing, file transmission, and direct printing.

4. The method according to claim 1, wherein the performing comprises performing the explored application program by click or automatically performing the application program.

5. The method according to claim 1, wherein the application program comprises at least one of a virtual user interface (UI) program corresponding to an operation panel of the image forming apparatus which enables a user to input and at least one widget displaying information of the image forming apparatus.

6. The method according to claim 5, wherein the virtual UI program displays a display area showing a current status of the image forming apparatus or a function of the image forming apparatus and at least one user input button.

7. The method according to claim 6, further comprising selecting an input button displayed by execution of the virtual UI program and controlling the image forming apparatus to correspond to the selected input button.

8. The method according to claim 5, wherein the widget comprises at least one of a plurality of programs loading and displaying status information, toner information, a scanner status, a fax status, and process information from the image forming apparatus and a widget manager controlling the plurality of programs.

9. The method according to claim 8, wherein the widget undergoes at least one of adding, deleting, and changing.

10. The method according to claim 8, wherein the displaying in the host apparatus comprises displaying a list of at least one program, and the method further comprises selecting one program from the list and displaying information of the image forming apparatus corresponding to the selected program.

11. The method according to claim 1, wherein the displaying in the host apparatus comprises displaying an icon corresponding to the application program on a system tray on a wallpaper of the host apparatus.

12. A host apparatus which is connectable with at least one image forming apparatus via a universal serial bus (USB), the host apparatus comprising:
a communication unit comprising a USB interface connected to an image forming apparatus having a storage unit in which at least one application program is stored;
a display displaying a user interface (UI) of the application program;
a memory loading the application program; and
a controller recognizing the image forming apparatus as a disk drive corresponding to a mass storage class to be displayed on the display when connecting with the image forming apparatus via the USB interface, exploring and executing the application program in the displayed disk drive to be loaded to the memory, and controlling the display to display the UI of the loaded application program.

13. The host apparatus according to claim 12, further comprising a user input unit comprising the displayed UI and receiving input by a user, wherein the controller controls the communication unit to transmit a command of driving the image forming apparatus corresponding to input by a user when inputting the input by the user to the displayed UI.

14. The host apparatus according to claim 13, wherein the driving the image forming apparatus comprises changing a pre-input setting value of the image forming apparatus, or displaying or executing a function supported by the image forming apparatus, and the function comprises at least one of printing, copying, scanning, faxing, file transmission, and direct printing.

15. The host apparatus according to claim 12, further comprising a user input unit receiving input by a user, wherein the controller performs the explored application program by click on the user input unit or allows the application program to be performed automatically.

16. The host apparatus according to claim 12, wherein the application program comprises at least one of a virtual user interface (UI) program corresponding to an operation panel of the image forming apparatus which enables a user to input and at least one widget displaying information of the image forming apparatus.

17. The host apparatus according to claim 16, wherein the virtual UI program displays a display area showing a current status of the image forming apparatus or a function of the image forming apparatus and at least one user input button.

18. The host apparatus according to claim 16, wherein the widget comprises at least one of a plurality of programs loading and displaying status information, toner information, a scanner status, a fax status, and process information from the image forming apparatus and a widget manager controlling the plurality of programs.

19. The host apparatus according to claim 12, wherein the display displays an icon corresponding to the application program on a system tray on a wall paper of the host apparatus.

20. An image forming apparatus which is connectable with at least one host apparatus via a universal serial bus (USB), the image forming apparatus comprising:
a communication unit comprising a USB interface to support a printer class and a mass storage class;
a storage unit in which a file allocation table (FAT) and at least one application program are stored; and
a controller informing the host apparatus that the USB interface supports the printer class and the mass storage class when connecting to the host apparatus via the USB interface and controlling the communication unit to load the application program to the host apparatus.

21. A method of controlling an image forming apparatus, comprising:
connecting an image forming apparatus to a host apparatus; and
downloading from the image forming apparatus an application to display a user interface corresponding to functions of the image forming apparatus on a display of the host apparatus,
wherein the application is saved and executed from a RAM device of the host apparatus.

22. The method according to claim 21, wherein the application is a virtual UI depicting a control panel having buttons corresponding to one or more functions of the image forming apparatus, and
the buttons are selectable by a user of the host apparatus to execute the corresponding one or more functions of the image forming apparatus.

23. The method according to claim 21, wherein the application is a widget application to display at least one icon corresponding to a function of the image forming apparatus, and
when a user selects the icon, data corresponding to the function of the image forming apparatus is displayed on the host apparatus.

24. An image forming apparatus, comprising:
an imaging unit to perform an imaging function of a document;
a data storage device to store at least one application to control operation of the image forming apparatus;
a data communication unit to connect to a host device to receive imaging commands from the host device; and
a controller to control transmission of data between the data storage device and the host device via the data communication unit, and to control the imaging unit,
wherein the data communication unit transmits the at least one application to the host device to provide a display on the host device corresponding to at least one function of the image forming apparatus,
wherein the data storage device includes a file allocation table to transmit to the host device, such that at least a portion of the data storage device is controllable by a user of the host device as a mass data storage device.

25. The image forming apparatus according to claim 24, wherein the application includes a virtual control panel to control operations of the imaging unit of the image forming apparatus.

26. The image forming apparatus according to claim 24, wherein the application includes at least one widget to display data corresponding to a status of a function of the image forming apparatus.
